(19) United States
(12) Patent Application Publication
(10) Pub. No.: US 2025/0357716 A1
(43) Pub. Date: Nov. 20, 2025

(54) GAS LASER APPARATUS, LASER GAS TEMPERATURE CONTROL METHOD, AND ELECTRONIC DEVICE MANUFACTURING METHOD

(71) Applicant: Gigaphoton Inc., Oyama-shi (JP)

(72) Inventors: Masakazu HATTORI, Oyama-shi (JP); Takahito KUMAZAKI, Oyama-shi (JP); Kouji KAKIZAKI, Oyama-shi (JP)

(73) Assignee: Gigaphoton Inc., Oyama-shi (JP)

(21) Appl. No.: 19/289,770

(22) Filed: Aug. 4, 2025

Related U.S. Application Data
(63) Continuation of application No. PCT/JP2023/007847, filed on Mar. 2, 2023.

(51) Int. Cl. H01S 3/041; H01S 3/034; H01S 3/036

(52) U.S. Cl. CPC H01S 3/041; H01S 3/034; H01S 3/036

(57) ABSTRACT

A gas laser apparatus that outputs pulsed laser light includes a laser chamber that accommodates laser gas, a discharge electrode that is disposed inside the laser chamber and is configured to cause discharge-excitation of the laser gas, an optical element that is disposed on an optical path of the pulsed laser light, and a processor configured to change a target temperature of the laser gas based on either a number of pulses of the pulsed laser light or an elapsed time during which the pulsed laser light is output.

### CROSS-REFERENCE TO RELATED APPLICATIONS

The present application is a continuation application of International Application No. PCT/JP2023/007847, filed on Mar. 2, 2023, the entire contents of which are hereby incorporated by reference.

### BACKGROUND

### 1. Technical Field

The present disclosure relates to a gas laser apparatus, a laser gas temperature control method, and an electronic device manufacturing method.

### 2. Related Art

In recent years, an improvement in resolutions of semiconductor exposure apparatuses has been desired with miniaturization and higher integration of semiconductor integrated circuits. For this purpose, exposure light sources that release light having a shorter wavelength have been developed. For example, a KrF excimer laser apparatus that outputs laser light having a wavelength of about 248 nm and an ArF excimer laser apparatus that outputs laser light having a wavelength of about 193 nm are used as gas laser apparatuses for exposure.

Spectral linewidths of spontaneous oscillation light of the KrF excimer laser apparatus and the ArF excimer laser apparatus are as wide as 350 pm to 400 pm. Therefore, chromatic aberration may occur if a projection lens is formed of a material that transmits ultraviolet light such as KrF and ArF laser light. As a result, resolving power may be degraded. Thus, a spectral linewidth of laser light output from the gas laser apparatus needs to be narrowed to the extent that chromatic aberration can be ignored. For this purpose, a line narrowing module (LNM) including a line narrowing element (etalon, grating, and the like) may be included in a laser resonator of the gas laser apparatus to narrow the spectral linewidth. Hereinafter, a gas laser apparatus with a narrowed spectral linewidth will be referred to as a line narrowing gas laser apparatus.

### LIST OF DOCUMENTS

### Patent Documents

Patent Document 1: US Published Patent Application No. 2017/0149199
Patent Document 2: Japanese Unexamined Patent Application Publication No. 2010-10553
Patent Document 3: US Published Patent Application No. 2021/0367390
Patent Document 4: Japanese Unexamined Patent Application Publication No. 2003-86874

### SUMMARY

A gas laser apparatus according to an aspect of the present disclosure is a gas laser apparatus that outputs pulsed laser light and includes a laser chamber that accommodates laser gas, a discharge electrode that is disposed inside the laser chamber and is configured to cause discharge-excitation of laser gas, an optical element that is disposed on an optical path of the pulsed laser light, and a processor configured to change a target temperature of the laser gas based on either a number of pulses of the pulsed laser light or an elapsed time during which the pulsed laser light is output.

A laser gas temperature control method according to another aspect of the present disclosure is a laser gas temperature control method for a gas laser apparatus that outputs pulsed laser light, the gas laser apparatus including a laser chamber that accommodates laser gas, a discharge electrode that is disposed inside the laser chamber and is configured to cause discharge-excitation of laser gas, an optical element that is disposed on an optical path of the pulsed laser light, and a processor, the method including, by the processor, changing a target temperature of the laser gas based on either a number of pulses of the pulsed laser light or an elapsed time during which the pulsed laser light is output.

An electronic device manufacturing method according to another aspect of the present disclosure includes generating laser light with a gas laser apparatus including a laser chamber that accommodates laser gas, a discharge electrode that is disposed inside the laser chamber and is configured to cause discharge-excitation of laser gas, an optical element that is disposed on an optical path of the pulsed laser light, and a processor configured to change a target temperature of the laser gas based on either a number of pulses of the pulsed laser light output by the discharge-excitation or an elapsed time during which the pulsed laser light is output, outputting the laser light to an exposure apparatus, and exposing a photosensitive substrate to the laser light within the exposure apparatus to manufacture an electronic device.

### BRIEF DESCRIPTION OF THE DRAWINGS

Some embodiments of the present disclosure will be described below merely as examples with reference to the accompanying drawings.

FIG. 1 schematically illustrates a configuration of a gas laser apparatus according to a comparative example.

FIG. 2 is a configuration diagram of a laser oscillator system rotated leftward by 90° from that illustrated in FIG. 1.

FIG. 3 is a flowchart of a laser oscillation operation in the gas laser apparatus according to the comparative example.

FIG. 4 is a flowchart of laser gas temperature control.

FIG. 5 is a flowchart illustrating a subroutine for processing of changing a laser gas temperature control mode applied to Step S26 in FIG. 4.

FIG. 6 is a graph illustrating transition of the laser gas temperature in the gas laser apparatus according to the comparative example.

FIG. 7 illustrates an example of a beam profile that is intensity distribution of pulsed laser light output from the laser oscillator system.

FIG. 8 is a graph illustrating an example of transition of a target temperature in laser gas temperature control of a gas laser apparatus according to an Embodiment 1.

FIG. 9 is a graph illustrating another example of the transition of the target temperature in the laser gas temperature control of the gas laser apparatus according to the Embodiment 1.

FIG. 10 is a graph illustrating another example of the transition of the target temperature in the laser gas temperature control of the gas laser apparatus according to the Embodiment 1.

FIG. 11 illustrates an example of a beam profile of pulsed laser light output during control at each of target temperatures changed within a range of 65° C. to 100° C.

FIG. 12 is a flowchart of the laser gas temperature control in the gas laser apparatus according to the Embodiment 1.

FIG. 13 is a flowchart illustrating a subroutine for processing of changing a target temperature applied to Step S50 in FIG. 12.

FIG. 14 is a flowchart illustrating a subroutine for processing of changing a laser gas temperature control mode applied to Step S56 in FIG. 12.

FIG. 15 illustrates an example of a beam profile in a case where the laser gas temperature is 65° C. and an average beam profile obtained in a case where the target temperature is changed within a range of 65° C. to 100° C.

FIG. 16 is a graph comparing peak intensities within beam profiles in a case where the average beam profile is calculated with a variation range of the target temperature changed.

FIG. 17 is a graph illustrating an example of transition of a target temperature in laser gas temperature control of a gas laser apparatus according to an Embodiment 2.

FIG. 18 is a graph illustrating another example of the transition of a target temperature in the laser gas temperature control of the gas laser apparatus according to the Embodiment 2.

FIG. 19 is a graph illustrating another example of the transition of the target temperature in the laser gas temperature control of the gas laser apparatus according to the Embodiment 2.

FIG. 20 is a flowchart of the laser gas temperature control in the gas laser apparatus according to the Embodiment 2.

FIG. 21 schematically illustrates a configuration of a gas laser apparatus according to an Embodiment 3.

FIG. 22 is a configuration diagram of a laser amplifier system rotated leftward by 90° from that illustrated in FIG. 21.

FIG. 23 schematically illustrates a configuration of an exposure apparatus.

### DESCRIPTION OF EMBODIMENTS

### Contents

1. Overview of gas laser apparatus according to comparative example
   1.1 Configuration
   1.2 Operation
   1.3 Problem
2. Embodiment 1
   2.1 Configuration
   2.2 Operation
   2.3 Effect and advantage
3. Embodiment 2
   3.1 Configuration
   3.2 Operation
   3.3 Effect
4. Embodiment 3
   4.1 Configuration
   4.2 Operation
   4.3 Effect and advantage
5. Embodiment 4
   5.1 Configuration
   5.2 Operation
   5.3 Effect and advantage
6. Embodiment 5
   6.1 Configuration
   6.2 Operation
   6.3 Effect and advantage
7. Concerning electronic device manufacturing method
8. Others

Hereinafter, embodiments of the present disclosure will be described in detail with reference to the drawings. The embodiments described below show some examples of the present disclosure and do not limit contents of the present disclosure. Not all configurations and operations described in each embodiment are necessarily essential as configurations and operations of the present disclosure. Note that the same components will be denoted by the same reference signs and repeated description thereof will be omitted.

### 1. Overview of Gas Laser Apparatus According to Comparative Example

### 1.1 Configuration

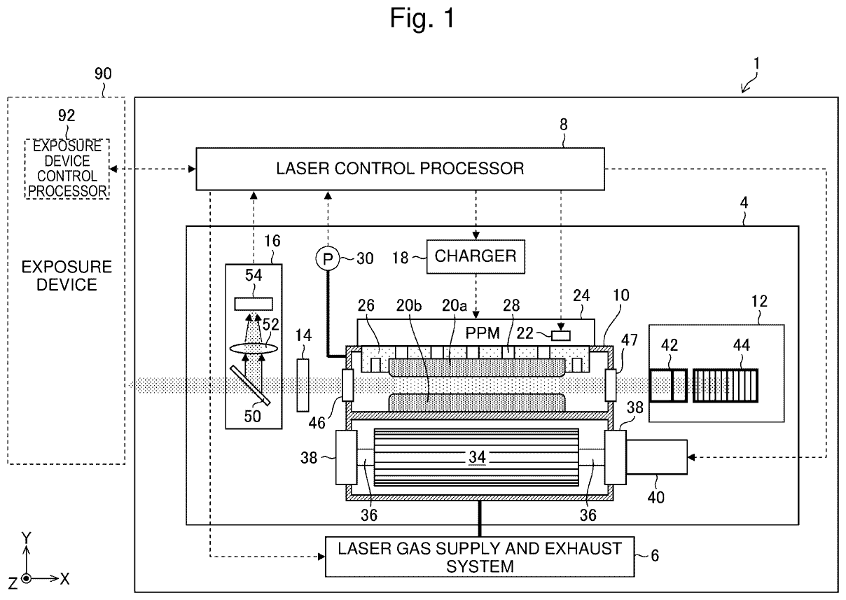

FIG. 1 illustrates a configuration diagram of a gas laser apparatus 1 according to a comparative example. The comparative example of the present disclosure is an example that the applicant recognizes as known only by the applicant, but is not a publicly known example that is recognized by the applicant. The gas laser apparatus 1 is an excimer laser apparatus that includes a laser oscillator system 4, a laser gas supply and exhaust system 6, and a laser control processor 8.

The laser oscillator system 4 includes a laser chamber 10, a line narrowing module (LNM) 12, an output coupling mirror (output coupler: OC) 14, a power monitor 16, and a charger 18.

The laser chamber 10 accommodates laser gas containing fluorine. A pair of discharge electrodes 20a and 20b for causing discharge-excitation of laser gas, a pulse power module (PPM) 24 that includes a switch 22 to cause the discharge electrodes 20a and 20b to perform pulse discharge, an electrical insulating unit 26, and a feedthrough 28 are disposed in the laser chamber 10. The discharge electrode 20a is a cathode electrode, and the discharge electrode 20b is an anode electrode. The electrical insulating unit 26 supports the discharge electrode 20a with the discharge electrode 20a insulated from the PPM 24.

The PPM 24 includes a charge capacitor, which is not illustrated, and is connected to the discharge electrode 20a via the feedthrough 28. The charger 18 is connected to the charge capacitor of the PPM 24. A voltage generated by the PPM 24 is applied to the discharge electrode 20a via the feedthrough 28.

Additionally, a pressure sensor 30, a cross-flow fan 34, a shaft 36 that causes the cross-flow fan 34 to rotate, a bearing 38 that fixes the shaft 36, and a motor 40 that provides a driving force to the shaft 36 are disposed in the laser chamber 10. The pressure sensor 30 measures the total pressure of the laser gas. The cross-flow fan 34 rotates within the laser chamber 10 to circulate the laser gas. The rotation of the cross-flow fan 34 causes the laser gas to circulate within the laser chamber 10.

The LNM 12 includes a prism 42 that enlarges a beam, and a grating 44. The grating 44 is disposed in Littrow arrangement such that an incident angle and a diffraction angle become the same. The OC 14 is a partial reflective mirror coated with a multi-layered film that reflects a part of laser light generated in the laser chamber 10 and transmits the other part. The OC 14 forms a laser resonator together with the LNM 12. The laser chamber 10 includes two windows 46 and 47 that transmit light of the laser resonator, and is disposed on an optical path of the laser resonator.

The power monitor 16 includes a beam splitter 50, a light condensing lens 52, and an optical sensor 54, which are disposed on an optical path of laser light output from the OC 14.

The laser gas supply and exhaust system 6 includes a laser gas supply system and a laser gas exhaust system, which are not illustrated. The laser gas supply system includes a flow rate control valve and is connected to a gas cylinder that serves as a source of the laser gas. The laser gas exhaust system includes an opening/closing valve and an exhaust pump. The laser may be, for example, Ar or Kr as rare gas, F₂ gas as halogen gas, Ne or He as buffer gas, or mixed gas thereof.

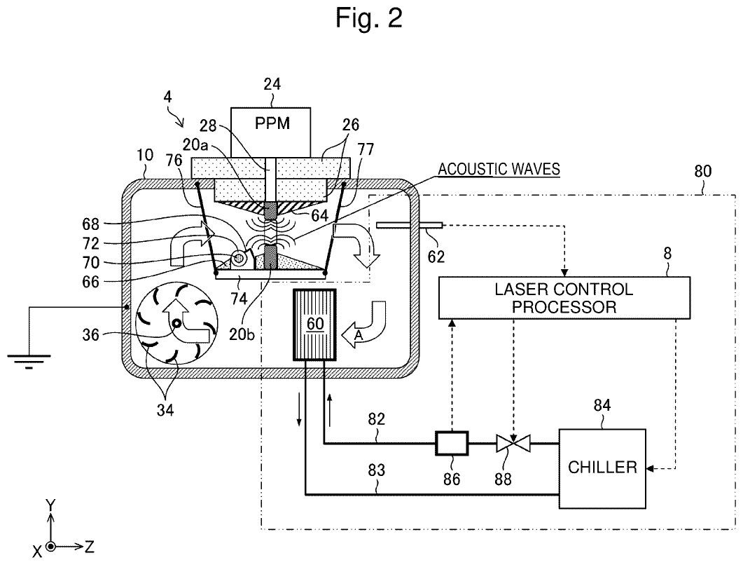

FIG. 2 illustrates a configuration diagram of the laser oscillator system 4 rotated leftward by 90° from that illustrated in FIG. 1. A heat exchanger 60, a temperature sensor 62, an insulating guide 64 and a metallic guide 66 for rectifying the laser gas, a pre-ionization outer electrode 68, a pre-ionization inner electrode 70, and a dielectric pipe 72 that cause corona discharge, a ground plate 74, and wirings 76 and 77 that hold the ground plate 74 in the laser chamber 10 are disposed in the laser chamber 10. The heat exchanger 60 changes the temperature of the laser gas circulating within the laser chamber 10. The temperature sensor 62 detects the temperature of the laser gas.

The gas laser apparatus 1 includes a laser gas temperature control system 80 that controls the temperature of the laser gas circulating within the laser chamber 10. The laser gas temperature control system 80 includes a laser control processor 8, a temperature sensor 62, a heat exchanger 60, refrigerant pipings 82 and 83 that circulate a refrigerant inside the heat exchanger 60, and a chiller 84 that supplies the refrigerant to the heat exchanger 60 via the refrigerant pipings 82 and 83.

The refrigerant piping 82 includes a flow rate sensor 86 and a valve 88. The flow rate sensor 86 detects the flow rate of the refrigerant distributed through the refrigerant piping 82. Flow rate information detected by the flow rate sensor 86 is sent to the laser control processor 8. The valve 88 is a valve that can be opened and closed in response to a signal from the laser control processor 8 and adjusts the flow rate of the refrigerant. The valve 88 may be an opening/closing valve or a flow rate control valve.

The chiller 84 that cools the refrigerant flowing inside is connected to the heat exchanger 60. The chiller 84 can freely change the set temperature of the refrigerant based on an instruction from the laser control processor 8, thereby controlling the temperature of the laser gas inside the laser chamber 10.

The laser control processor 8 is electrically connected to the temperature sensor 62 and is capable of measuring the temperature of the laser gas inside the laser chamber 10 based on an output signal of the temperature sensor 62. The laser control processor 8 controls the valve 88 based on the measurement result of the temperature sensor 62. Note that a plurality of gas laser apparatuses, which are not illustrated, may be connected to the chiller 84. The chiller 84 may be connected to other apparatuses, which are not illustrated.

The laser control processor 8 functions as a control device for the gas laser apparatus 1. The laser control processor 8 is a processing device including a storage device that stores a control program and a central processing unit (CPU) that executes the control program. The laser control processor 8 is specially configured or programmed to execute various kinds of processing included in the present disclosure. The storage device is a non-transitory computer-readable medium as a tangible entity and includes, for example, a memory that is a main storage device and a storage that is an auxiliary storage device. The computer-readable medium may be, for example, a semiconductor memory, a hard disk drive (HDD) device, a solid-state drive (SSD) device, or a combination of a plurality of these devices. The laser control processor 8 is electrically connected to an exposure device control processor 92 of an exposure device 90.

### 1.2 Operation

The laser chamber 10 is filled with laser gas supplied from the laser gas supply system, and the laser gas continuously circulates in the direction of the white outlined arrow A in FIG. 2 inside the laser chamber 10 by the cross-flow fan 34 that rotates continuously.

The laser gas is rectified by inclined surfaces of the insulating guide 64 and the metallic guide 66 and is supplied to a discharge space. The discharge space includes a space between the discharge electrodes 20a and 20b. The flow speed of the laser gas passing through the discharge space is improved by the rectification, and thus a discharge product generated in the discharge space can be efficiently removed from the discharge space. As a result, arc discharge due to the discharge product is suppressed.

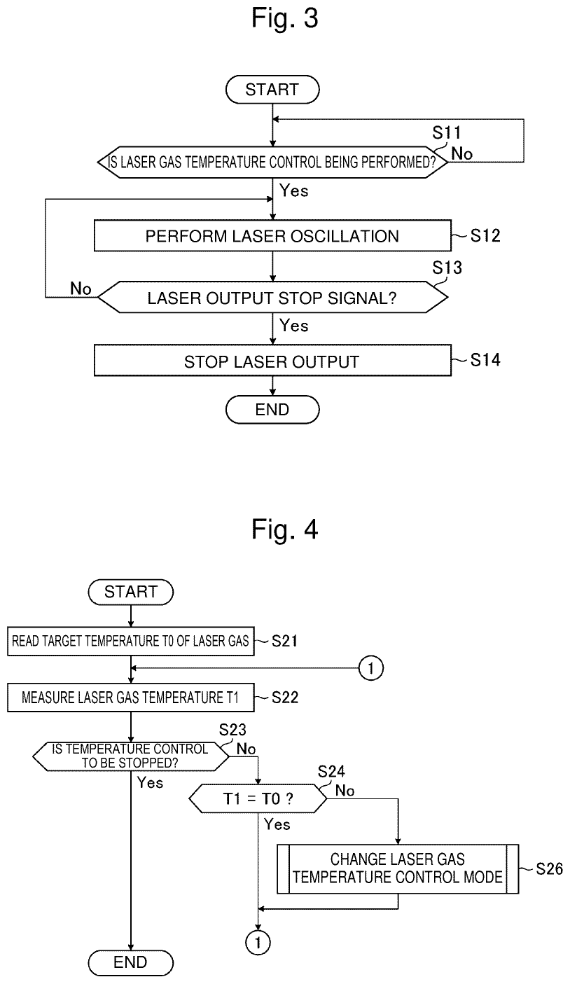

FIG. 3 is a flowchart of a laser oscillation operation in the gas laser apparatus 1 according to the comparative example. Once the laser oscillation flow illustrated in FIG. 3 is started, the laser control processor 8 determines whether or not the temperature of the laser gas is being controlled in Step S11. In a case where No determination is made as a determination result in Step S11, that is, if the temperature control of the laser gas has not been started, the laser control processor 8 repeats Step S11. On the other hand, in a case where Yes determination is made as a determination result in Step S11, that is, after the temperature control of the laser gas is started, the laser control processor 8 moves on to Step S12. Note that the laser gas temperature control flow will be described later using FIG. 4.

In Step S12, the laser control processor 8 applies a high voltage to the charger 18 based on a luminous trigger signal received from the exposure device control processor 92 and target pulse energy, thereby causing laser light to oscillate. Once the laser control processor 8 receives the luminous trigger signal from the exposure device control processor 92, the laser control processor 8 causes the switch 22 in the PPM 24 to operate to apply a high voltage between electrodes, namely between the pre-ionization outer electrode 68 and the pre-ionization inner electrode 70, which are the pre-ionization electrodes in the laser chamber 10, and the discharge electrodes 20a and 20b, which are the main discharge electrodes.

As a result, corona discharge occurs at the pre-ionization electrodes first, and discharge ultraviolet light (UV light) is generated. The laser gas is pre-ionized by the laser gas between the main discharge electrodes being irradiated with the UV light. Thereafter, main discharge occurs between the discharge electrodes 20a and 20b, the laser gas is excited, and laser oscillation occurs in the laser resonator including the OC 14 and the grating 44.

At this time, pulsed laser light narrowed by the prism 42 and the grating 44 is output from the OC 14. A part of the pulsed laser light output from the OC 14 is incident on the power monitor 16, a part thereof is reflected by the beam splitter 50, and pulse energy of output laser light is detected by the optical sensor 54 via the light condensing lens 52.

The pulse energy of the output laser light detected by the power monitor 16 is input to the laser control processor 8. The laser control processor 8 integrates a number of pulses of the laser light in a counter circuit provided in the laser control processor 8 based on the output of the power monitor 16. Note that the integration of the number of pulses may be performed based on the luminous trigger signal. The laser light having been transmitted through the beam splitter 50 is output toward the exposure device 90.

In Step S13, the laser control processor 8 determines whether or not to interrupt the laser oscillation based on a signal from the exposure device control processor 92. In a case where No determination is made as a determination result in Step S13, that is, while the laser control processor 8 does not receive a signal to interrupt the exposure from the exposure device control processor 92, the processing returns to Step S12, and the following steps are repeated. While the gas laser apparatus 1 is operating, the laser control processor 8 performs feedback control on the high voltage with which the charger 18 is charged, based on a difference between the target pulse energy and the actually output pulse energy.

In a case where Yes determination is made as a determination result in Step S13, that is, in a case where the laser control processor 8 receives the signal to interrupt the exposure from the exposure device control processor 92, the processing proceeds to Step S14.

In Step S14, the laser control processor 8 stops the output of laser light to the exposure device 90 by stopping the laser oscillation or causing an optical shutter to move to the laser optical path. After Step S14, the flowchart in FIG. 3 is ended.

FIG. 4 is a flowchart of laser gas temperature control in the gas laser apparatus 1. Once the laser gas temperature control flow illustrated in FIG. 4 is started, the laser control processor 8 sets a target temperature T0 of the laser gas such that pulsed laser light of target pulse energy is output in Step S21. Note that the target temperature T0 is a temperature of a predetermined value corresponding to the target pulse energy.

In Step S22, the laser control processor 8 acquires a current laser gas temperature T1 in the laser chamber 10 from an output of the temperature sensor 62.

In Step S23, the laser control processor 8 determines whether or not to stop temperature control based on a signal from the exposure device control processor 92. In a case where No determination is made as a determination result in Step S23, that is, if the laser control processor 8 does not receive a stop signal, the laser control processor 8 moves on to Step S24 and continues the temperature control.

In Step S24, the laser control processor 8 compares the laser gas temperature T1 with the target temperature TO and determines whether or not T1=T0 is satisfied. In a case where Yes determination is made as a determination result in Step S24, that is, in a case where the laser gas temperature T1 is determined to be equal to the target temperature T0, the laser control processor 8 returns to Step S22.

In a case where No determination is made as a determination result in Step S24, that is, in a case where the laser gas temperature T1 is determined not as the target temperature T0, the laser control processor 8 moves on to Step S26.

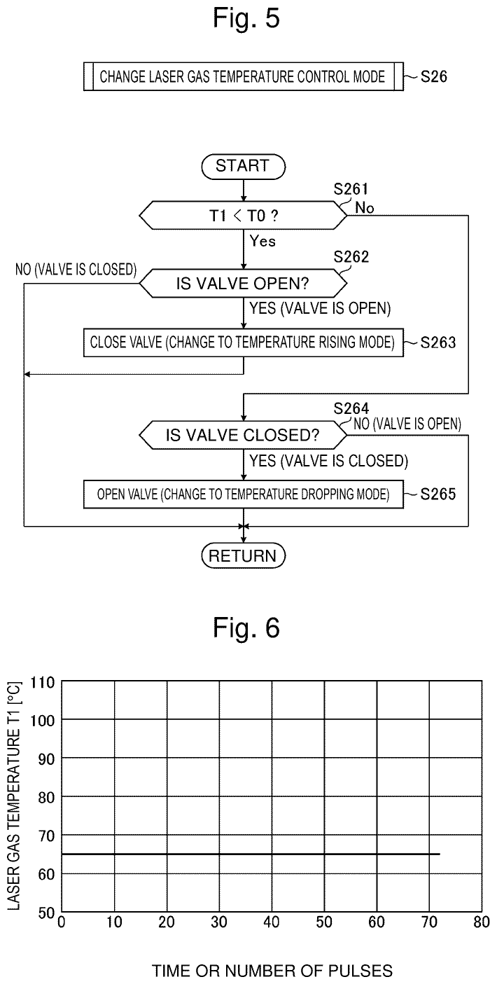

In Step S26, the laser control processor 8 executes processing of changing a laser gas temperature control mode. In Step S26, the laser gas temperature control system 80 executes an operation of changing a cooling effect on the laser gas such that the laser gas temperature T1 reaches the target temperature T0. Details of the processing of changing the laser gas temperature control mode applied to Step S26 will be described later using FIG. 5. After Step S26, the laser control processor 8 returns to Step S22.

In a case where Yes determination is made as a determination result in Step S23, that is, in a case where the laser control processor 8 receives a stop signal, the flowchart in FIG. 4 is ended to stop the temperature control.

FIG. 5 is a flowchart illustrating a subroutine for the processing of changing the laser gas temperature control mode applied to Step S26 in FIG. 4. Although the operation flow illustrated in FIG. 5 assumes that the flow rate of the refrigerant supplied to the heat exchanger 60 is controlled by opening and closing the valve 88 in the laser gas temperature control system 80, the operation flow is not limited to this example, and the laser gas temperature may be controlled by a method of controlling the temperature of the refrigerant supplied from the chiller 84 or a combination thereof. Furthermore, the opening and closing of the valve 88 may be simple opening/closing control or may be flow rate control that can change the flow rate in a stepwise manner or a continuous manner. The opening and closing control of the valve 88 is an example of a method for adjusting the flow rate of the refrigerant.

Once the processing of changing the laser gas temperature control mode illustrated in FIG. 5 is started, the laser control processor 8 determines whether the current laser gas temperature T1 is lower or higher than the target temperature T0 in Step S261. For example, the laser control processor 8 determines whether T1<T0 is satisfied, and in a case where Yes determination is made as a determination result in Step S261, the laser control processor 8 determines that the laser gas temperature T1 has not reached the target temperature T0 and the temperature needs to be raised, and moves on to Step S262.

In Step S262, the laser control processor 8 determines an opening and closing state of the valve 88. For example, the laser control processor 8 determines whether or not the valve 88 is in an open state, and in a case where Yes determination is made as a determination result in Step S262, that is, if the valve 88 is in an open state, the laser control processor 8 moves on to Step S263.

In Step S263, the laser control processor 8 closes the valve 88 to reduce the cooling effect and stops the supply of refrigerant. The cooling effect of the heat exchanger 60 is reduced, and the laser temperature T1 is gradually raised by the supply of the refrigerant being stopped. The operation of raising the laser gas temperature T1 as in Step S263 is defined as a “temperature rising mode”. After Step S263, the laser control processor 8 ends the flowchart in FIG. 5 and returns to the flowchart in FIG. 4.

On the other hand, in a case where No determination is made as a determination result in Step S262, that is, if the valve 88 is in a closed state, this means that a state where the cooling effect is low has already been achieved, the valve 88 is thus kept closed, and the laser control processor 8 ends the flowchart in FIG. 5 and returns to the flowchart in FIG. 4.

In a case where No determination is made as a determination result in Step S261, the laser control processor 8 determines that the laser gas temperature T1 is higher than the target temperature T0 and the temperature needs to be lowered, and moves on to Step S264.

In Step S264, the laser control processor 8 determines an opening and closing state of the valve 88. For example, the laser control processor 8 determines whether or not the valve 88 is in a closed state, and in a case where Yes determination is made as a determination result in Step S264, that is, if the valve 88 is in the closed state, the laser control processor 8 moves on to Step S265.

In Step S265, the laser control processor 8 opens the valve 88 to enhance the cooling effect and restarts the supply of the refrigerant. The cooling effect of the heat exchanger 60 is improved, and the laser gas temperature T1 gradually drops by the supply of the refrigerant being restarted. The operation of lowering the laser gas temperature T1 as in Step S265 is defined as a “temperature dropping mode”.

On the other hand, in a case where No determination is made as a determination result in Step S264, that is, if the valve 88 is in an open state, this means that a state where the cooling effect is high has already been achieved, the valve 88 is thus kept open, and the laser control processor 8 ends the flowchart in FIG. 5 and returns to the flowchart in FIG. 4.

Here, the target temperature T0 is in principle set as a fixed value during product adjustment of the gas laser apparatus 1, and the gas laser apparatus 1 is used in a state where that target temperature T0 is set. The target temperature T0 is typically 65° C., for example. The change in laser gas temperature control mode described in FIG. 5 is carried out independently of presence or absence of laser oscillation.

Through the above operation, the pulsed laser light is output in a state controlled such that the laser gas temperature T1 is kept constant regardless of elapse of time during which laser oscillation is executed and elapse of a number of output pulses as illustrated in FIG. 6. The horizontal axis in FIG. 6 may be time or the number of pulses.

### 1.3 Problem

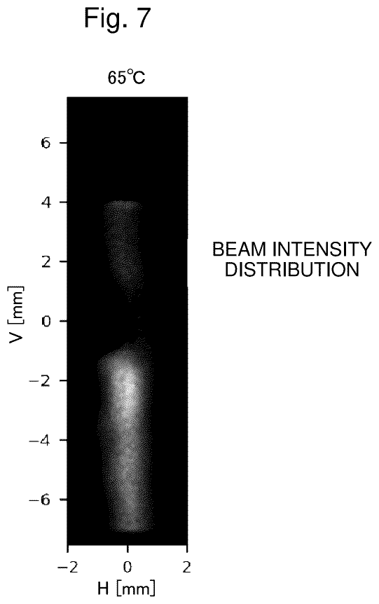

FIG. 7 illustrates an example of a beam profile, which is intensity distribution of pulsed laser light output from the laser oscillator system 4. In FIG. 7, the V direction (vertical axis) represents the discharge direction, while the H direction (horizontal axis) represents the electrode width direction of the discharge electrodes 20a and 20b. FIG. 7 illustrates a beam profile of the pulsed laser light output from the laser oscillator system 4 operating at a temperature of 65° C. and an oscillation frequency of 6000 Hz inside the laser chamber 10. This beam profile is obtained by simulating density distribution of acoustic waves generated based on the internal structure of the laser chamber 10 and calculating the beam profile (a result of the simulation). In FIG. 7, the beam profile expressing beam intensity distribution by a shade heat map is illustrated, where higher intensity is displayed brighter (with higher brightness).

In an outgoing beam output from the laser oscillator system 4, refractive index distribution is generated by the density of the acoustic waves occurring in the laser chamber 10 during discharge, and it is possible to ascertain that the intensity distribution has occurred in the beam profile. The acoustic waves here refer to shock waves generated in the discharge space by pulse discharge, which have been reflected by the ground plate 74, the dielectric pipes 72, and the insulating guide 64 and the like around the discharge electrodes 20a and 20b, and have returned to the discharge space, causing density fluctuations in the laser gas in the discharge space. An image of these acoustic waves is schematically illustrated in FIG. 2.

Although the beam profile illustrated in FIG. 7 is intensity distribution calculated by simulation, it has also been confirmed that intensity distribution similar to the simulation result is obtained even in the actual measurement results obtained by actually measuring the beam profile. At this time, local degradation occurs at the peak intensity position within the beam profile in the OC14. Such degradation may occur not only in the OC14 but also in optical elements such as the windows 46 and 47 and the prism 42.

In other words, the density distribution of the laser gas in the discharge space changes under influences of the acoustic waves, and this change in density distribution causes the intensity distribution in the pulsed laser light. Although a difference in intensity distribution of the pulsed laser light is relatively small within each pulse, the intensity distribution may be integrated in the optical elements and a location where degradation locally progresses may occur if oscillation is repeated. As a result, the lifespan of the optical elements is shortened.

### 2. Embodiment 1

### 2.1 Configuration

A gas laser apparatus according to an Embodiment 1 is different from the gas laser apparatus 1 according to the comparative example in that a target temperature in laser gas temperature control is changed in accordance with an integrated value of a numbers of pulses. The other configurations are similar to the configurations of the gas laser apparatus 1 illustrated in FIGS. 1 and 2.

### 2.2 Operation

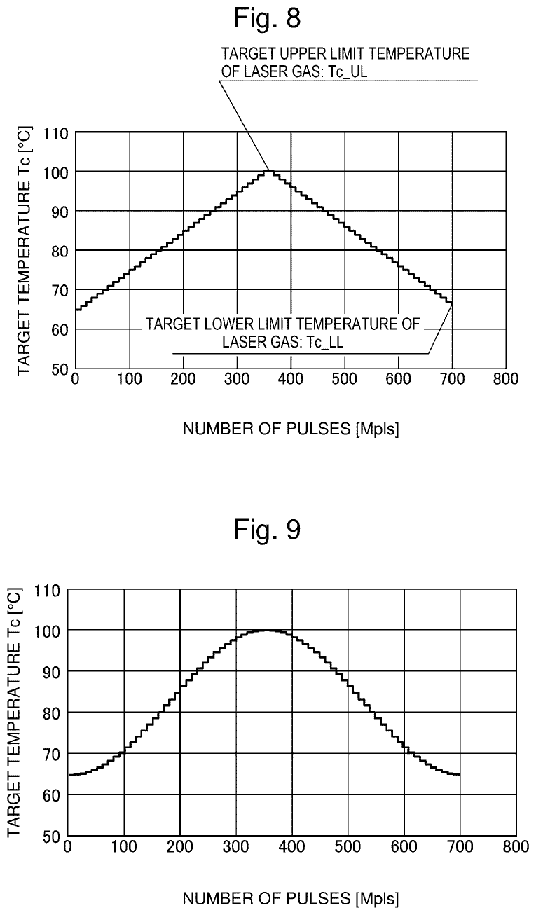

FIG. 8 is a graph illustrating an example of transition of the target temperature in the laser gas temperature control of the gas laser apparatus according to the Embodiment 1. The horizontal axis represents the number of pulses, and the vertical axis represents the target value. The laser control processor 8 in the Embodiment 1 changes the target temperature Tc of the laser gas inside the laser chamber 10 in a plurality of stages for each certain number of pulses within a range from a target lower limit temperature Tc_LL to a target upper limit temperature Tc_UL, thereby changing the target temperature Tc periodically as illustrated in FIG. 8. The cycle referred to here means a period until the target temperature Tc starting from Tc_LL reaches Tc_UL and then returns to Tc_LL by minutely changing the target temperature Tc based on the number of pulses or the elapsed time.

FIG. 8 illustrates an example in which Tc_LL is set to 65° C., Tc_UL is set to 100° C., and the target temperature Tc is changed by 1° C. for every increase of 10 Mpls (mega pulses) in the number of pulses, and the cycle in this case is 700 Mpls. The cycle for changing the target temperature Tc is preferably between 350 Mpls and 3500 Mpls. Although FIG. 8 illustrates transition for one cycle, the change in target temperature Tc is repeated periodically in the cycle as illustrated in FIG. 8.

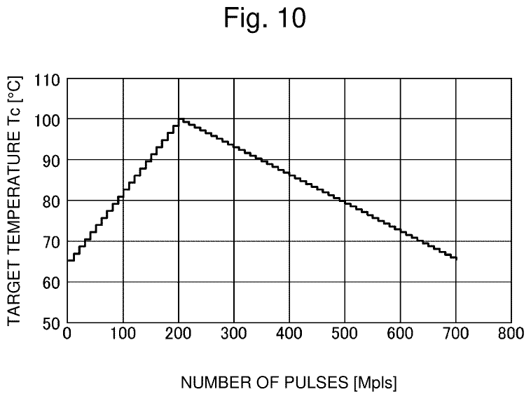

The method of changing the target temperature Tc in the stages within the range from Tc_LL to Tc_UL for every certain number of pulses in response to an increase in the number of pulses is not limited to the example in FIG. 8. The target temperature Tc may be changed in a stepwise manner along a triangular wave as in FIG. 8, or the target temperature Tc may not only be changed along the triangular wave but also may be changed along a sine wave as illustrated in FIG. 9 or a sawtooth wave as illustrated in FIG. 10. The transition of the target temperature Tc illustrated in each of FIGS. 8 to 10 is an example of the method for periodically changing the target temperature Tc within the range from Tc_LL to Tc_UL.

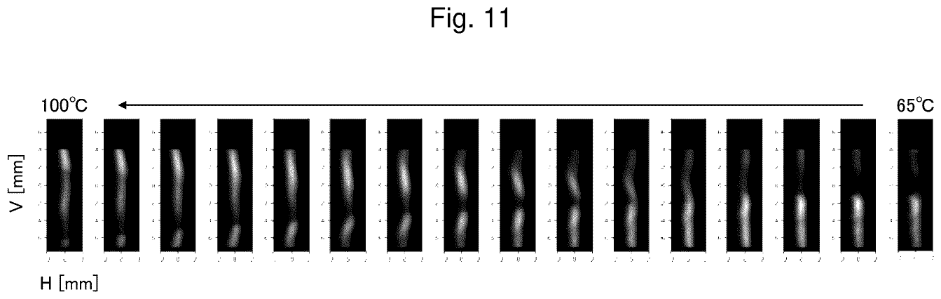

FIG. 11 illustrates an example of a beam profile of pulsed laser light output during control at each target temperature Tc changed within the range of 65° C. to 100° C. FIG. 11 illustrates intensity distribution calculated by simulation similarly to FIG. 7. Since the speed of sound in gas depends on the temperature of the gas, the density distribution of acoustic waves changes by the temperature inside the laser chamber 10 being changed. As a result, the beam profile changes in accordance with the temperature of the laser gas as illustrated in FIG. 11.

The change in target temperature Tc is preferably about 1° C. at 10 Mpls, for example, from perspectives of a degradation rate of the optical elements and stability of output performance.

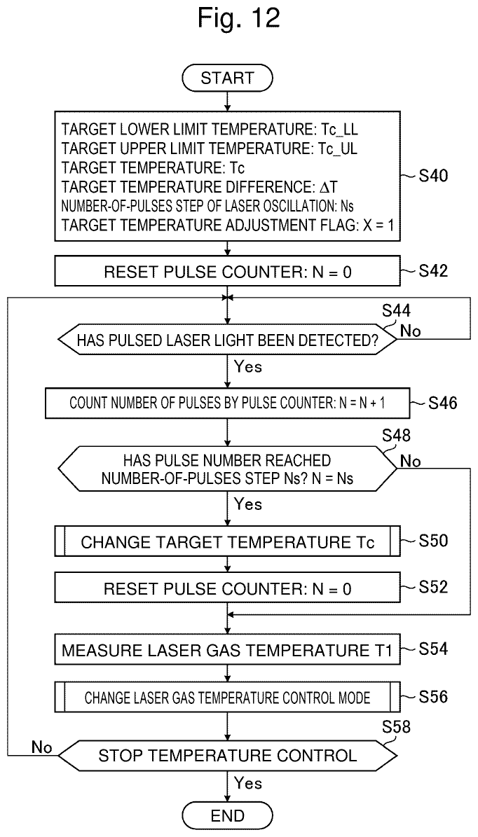

FIG. 12 is a flowchart of laser gas temperature control in the gas laser apparatus according to the Embodiment 1. Once the temperature control flow illustrated in FIG. 12 is started, the laser control processor 8 sets a value of each of parameters, namely the target lower limit temperature Tc_LL, the target upper limit temperature Tc_UL, the target temperature Tc, a target temperature difference ΔT, the number-of-pulses step Ns for laser oscillation, and a target temperature adjustment flag X of the laser gas in Step S40. In an example of specific values, Tc_LL may be 65° C., for example, and Tc_UL may be 100° C., for example. Tc_LL is an example of the “lower limit temperature” in the present disclosure, and Tc_UL is an example of the “upper limit temperature” in the present disclosure. An initial value of Tc may be either Tc_LL or Tc_UL, or a temperature between Tc_LL and Tc_UL. ΔT is the amount of change when the target temperature Tc is minutely changed. ΔT may be, for example, between 0.5° C. and 1° C. Ns represents the number of pulses that defines the timing for changing the target temperature Tc by ΔT, and the target temperature Tc is minutely changed each time the count value (integrated value) obtained by counting the number of pulses reaches Ns. Ns may be, for example, 5 Mpls to 50 Mpls. X is a flag that defines whether to increase or decrease the target temperature Tc. The initial value of X is set to, for example, “1.”

In Step S42, the laser control processor 8 resets the pulse counter. In other words, the laser control processor 8 initializes the value of the number N of pulses stored in the counter circuit provided in the laser control processor 8 to set N=0.

In Step S44, the laser control processor 8 determines whether or not the pulsed laser light has been detected. In a case where No determination is made as a determination result in Step S44, that is, in a case where the output of the power monitor 16 does not exceed a threshold value, the laser control processor 8 determines that the pulsed laser light has not been output and repeats Step S44.

On the other hand, in a case where Yes determination is made as a determination result in Step S44, that is, in a case where the output of the power monitor 16 exceeds the threshold value, the laser control processor 8 determines that the pulsed laser light has been output and moves on to Step S46. Note that instead of Step S44, presence or absence of an input of a luminous trigger signal may be detected, and in a case where the number of pulses of the pulsed laser light is counted based on the luminous trigger signal, the processing proceeds to Step S46 if there is an input of the luminous trigger signal.

In Step S46, the laser control processor 8 increments the counter of the counter circuit and performs the integration of the counts of the number N of pulses.

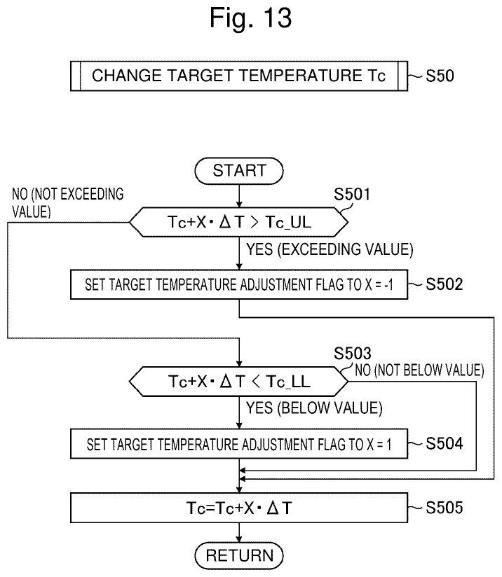

In Step S48, the laser control processor 8 determines whether or not the number N of pulses has reached the number-of-pulses step Ns. In a case where No determination is made as a determination result in Step S48, that is, the number N of pulses has not reached Ns, the processing proceeds to S54. On the other hand, in a case where Yes determination is made as a determination result in Step S48, that is, in a case where the number N of pulses has reached Ns, the processing proceeds to Step S50 to execute a flow of changing the target temperature Tc of the laser gas. Details of the processing flow applied to Step S50 will be described later using FIG. 13.

Once the change in the target temperature Tc of the laser gas is completed by Step S50, the processing proceeds to Step S52. In Step S52, the laser control processor 8 resets the pulse counter. In other words, the number N of pulses is set to “0”.

In Step S54, the laser control processor 8 measures the current laser gas temperature T1 inside the laser chamber 10 from the output of the temperature sensor 62.

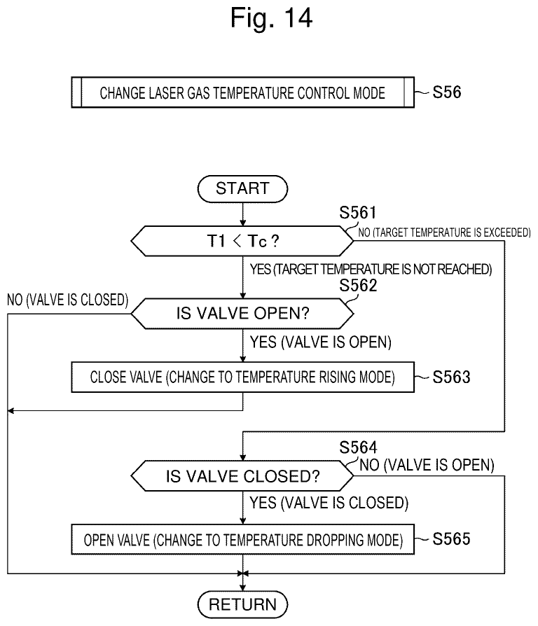

In Step S56, the laser control processor 8 executes temperature control of the laser gas at the target temperature Tc. Details of the processing of changing the laser gas temperature control mode applied to Step S56 will be described later using FIG. 14.

In Step S58, the laser control processor 8 determines whether or not to stop the temperature control. In a case where No determination is made as a determination result in Step S58, the laser control processor 8 returns to Step S44. In a case where Yes determination is made as a determination result in Step S58, the laser control processor 8 ends the flowchart in FIG. 12.

FIG. 13 is a flowchart illustrating a subroutine for processing of changing a target temperature Tc applied to Step S50 in FIG. 12. Once the flow for changing the target temperature Tc illustrated in FIG. 13 is started, the laser control processor 8 determines whether or not the target upper limit temperature Tc_UL is exceeded in a case where the target temperature Tc of the laser gas is changed by X·ΔT in Step S501. In a case where Yes determination is made as a determination result in Step S501, the laser control processor 8 determines that the temperature needs to be lowered and moves on to Step S502. In Step S502, the laser control processor 8 sets the value of the target temperature adjustment flag X to “−1” to lower the temperature. After Step S502, the processing proceeds to Step S505.

On the other hand, in a case where No determination is made as a determination result in Step S501, the laser control processor 8 determines that the temperature needs to be raised or the current temperature needs to be maintained and moves on to Step S503.

In Step S503, the laser control processor 8 determines whether or not the target temperature Tc of the laser gas becomes lower than the target lower limit temperature Tc_LL in a case where the target temperature Tc is changed by X·ΔT. In a case where Yes determination is made as a determination result in Step S503, the laser control processor 8 determines that the temperature needs to be raised and moves on to Step S504. In Step S504, the laser control processor 8 sets the value of the target temperature adjustment flag X to “1” to raise the temperature. After Step S504, the processing proceeds to Step S505.

On the other hand, in a case where No determination is made as a determination result in Step S503, the laser control processor 8 determines that a current temperature changing policy needs to be maintained and moves on to Step S505.

In Step S505, the laser control processor 8 changes the target temperature Tc by X·ΔT and updates the value of the target temperature Tc.

After Step S505, the laser control processor 8 ends the flowchart in FIG. 13 and returns to the flowchart in FIG. 12.

FIG. 14 is a flowchart illustrating a subroutine for the processing of changing the laser gas temperature control mode applied to Step S56 in FIG. 12. Once the flow for changing the laser gas temperature control mode illustrated in FIG. 14 is started, the laser control processor 8 determines whether or not the current laser gas temperature T1 is lower than the target temperature Tc in Step S561. In a case where Yes determination is made as a determination result in Step S561, that is, in a case where the current laser gas temperature T1 has not reached the target temperature Tc, the laser control processor 8 determines that the temperature needs to be raised and moves on to Step S562.

On the other hand, in a case where No determination is made as a determination result in Step S561, that is, in a case where the current laser gas temperature T1 exceeds the target temperature Tc, the laser control processor 8 determines that the temperature needs to be lowered and moves on to Step S564.

Each of Steps S562 to S565 is similar to a corresponding step in Steps S262 to S265 described in FIG. 5. The laser control processor 8 adjusts the flow rate of the refrigerant to bring the laser gas closer to the target temperature Tc by controlling the valve 88 based on the measurement result of the temperature sensor 62.

In this manner, the laser control processor 8 periodically repeats the operation of changing the target temperature Tc when the number N of pulses increases by Ns based on the count value of the number N of pulses. The laser gas temperature control method according to the Embodiment 1 is an example of the laser gas temperature control method in the present disclosure. The laser control processor 8 that executes the flowcharts in FIG. 12 to FIG. 14 is an example of the “processor” in the present disclosure.

### 2.3 Effect and Advantage

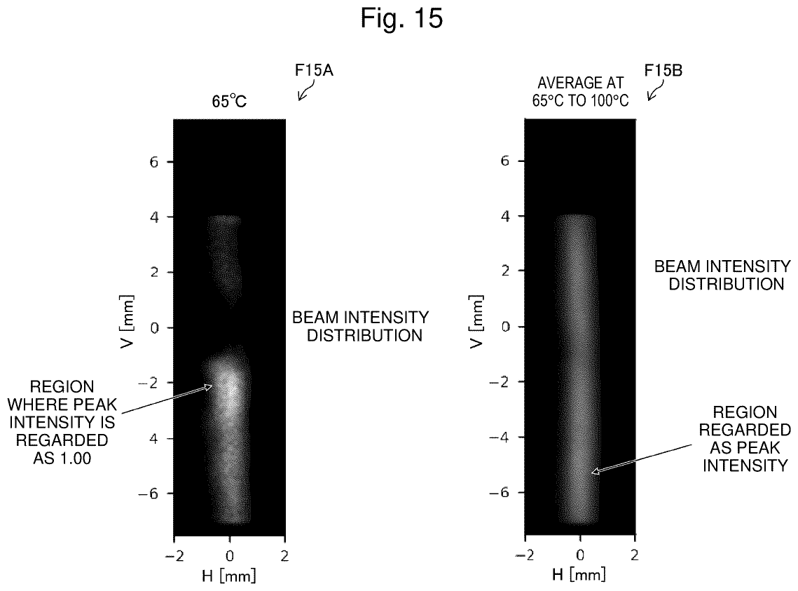

FIG. 15 illustrates comparison between a beam profile in a case where the laser gas temperature is 65° C. (F15A) and an average beam profile obtained in a case where the target temperature Tc is changed in the range of 65° C. to 100° C. (F15B). 65° C. is an example of the “specific temperature” in the present disclosure. If the average beam profile is calculated from a beam profile (see FIG. 11) obtained at each temperature in a case where the target temperature Tc is changed for each specific number of pulses within the range of 65° C. to 100° C., the beam profile as illustrated in the right diagram F15B is then obtained. The average beam profile illustrated in the right diagram F15B is obtained by integrating the beam profile at each temperature from 65° C. to 100° C. and dividing the result by the number of shots.

If a peak intensity with respect to an average intensity in the beam profile is calculated for each of the beam profiles illustrated in the left diagram F15A and the right diagram F15B in FIG. 15, the peak intensity of the average beam profile (right diagram F15B) at 65° C. to 100° C. then decreases to 44% relative to a reference, which is the peak intensity of the beam profile (left diagram F15A) at 65° C.

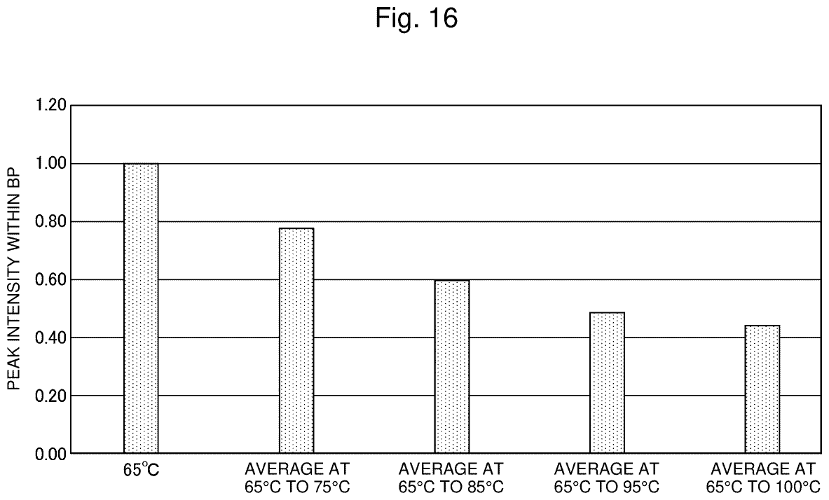

FIG. 16 is a graph comparing the peak intensity within each beam profile (BP) in a case where the average beam profile is calculated with the variation range of the target temperature Tc changed. FIG. 16 illustrates the peak intensity within each average beam profile in a case where the peak intensity within the beam profile at 65° C., which is a reference of the comparison, is defined as 1.00 and the variation range of the target temperature Tc is defined as “65° C. to 75° C.”, “65° C. to 85° C.”, “65° C. to 95° C.”, and “65° C. to 100° C.”.

As illustrated in FIG. 16, the peak intensity of the average beam profile is 78% the peak intensity of the beam profile at 65° C. when the temperature is changed from 65° C. to 75° C., is 60% when the temperature is changed from 65° C. to 85° C., and is 49% when the temperature is changed from 65° C. to 95° C.

The local beam intensity within the average beam profile decreases by changing the laser gas temperature inside the laser chamber 10 in this manner. If damage on the optical elements disposed on the laser optical path is considered to be caused by two-photon absorption, the occurrence probability of two-photon absorption is proportional to the square of the laser intensity, and therefore, if the beam intensity decreases to 44% on average from 65° C. to 100° C., for example, the occurrence probability of two-photon absorption decreases to ⅕ the occurrence probability at 65° C., and a lifespan extension of about five times is expected.

The target temperature range is preferably adjusted such that the peak intensity of the average beam profile is suppressed to 70% or less than the peak intensity of the beam profile at 65° C. (the reference peak intensity) to achieve a lifespan of twice or more than the lifespan achieved in the related art. It is more preferable that the target temperature range be adjusted such that the peak intensity of the average beam profile becomes 57% or less than the reference peak intensity to achieve a lifespan of three times or more than the lifespan achieved in the related art. It is even more preferable that the target temperature range be adjusted such that the peak intensity of the average beam profile becomes 50% or less than the reference peak intensity to achieve a lifespan of four times or more than the lifespan achieved in the related art. It is yet more preferable that the target temperature range be adjusted such that the peak intensity of the average beam profile becomes 44% or less than the reference peak intensity to achieve a lifespan of five times or more than the lifespan achieved in the related art. Note that the target temperature range is a variation range of the target temperature Tc defined by the target lower limit temperature Tc_LL and the target upper limit temperature Tc_UL, and the adjustment of the target temperature range is performed by setting the target lower limit temperature Tc_LL and the target upper limit temperature Tc_UL.

As described above, according to the Embodiment 1, the density distribution of the laser gas in the discharge space changes, and the intensity distribution of the pulsed laser light changes by changing the temperature of the laser gas for each specific number of pulses. The intensity distribution integrated in the optical elements such as OC14 is leveled by the intensity distribution being changed in this manner. As a result, local degradation of the optical elements is suppressed, and the lifespan is extended.

### 3. Embodiment 2

### 3.1 Configuration

The gas laser apparatus according to an Embodiment 2 is different from the gas laser apparatus according to the Embodiment 1 in that a target temperature Tc in laser gas temperature control is changed in accordance with an elapsed time. In other words, while the target temperature Tc is changed in accordance with the number of pulsed in the Embodiment 1, the target temperature Tc is changed in accordance with the elapsed time during which pulsed laser light is output instead of the number of pulses in the Embodiment 2. The elapsed time may be understood as a cumulative time of laser oscillation. The other configurations may be similar to the configurations of the gas laser apparatus according to the Embodiment 1.

### 3.2 Operation

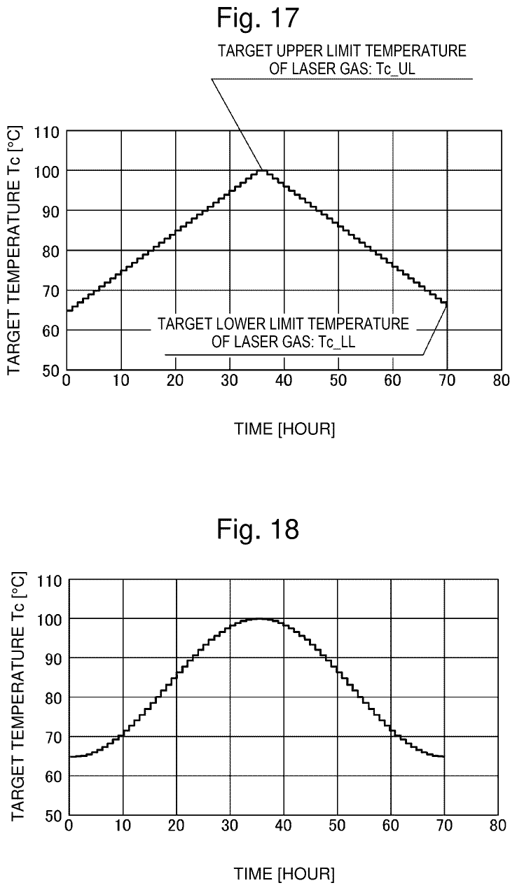

FIG. 17 is a graph illustrating an example of transition of the target temperature Tc in the laser gas temperature control of the gas laser apparatus according to the Embodiment 2. The horizontal axis represents time, and the vertical axis represents the target temperature Tc. A laser control processor 8 in the Embodiment 2 changes the target temperature Tc of the laser gas inside a laser chamber 10 in a plurality of stages within a range from a target lower limit temperature Tc_LL to a target upper limit temperature Tc_UL for each specific elapsed time, thereby changing the target temperature Tc periodically as illustrated in FIG. 17, for example.

FIG. 17 illustrates an example in which Tc_LL is set to 65° C., Tc_UL is set to 100° C., and the target temperature Tc is changed by 1° C. each time the elapsed time increases by 1 hour (60 minutes), and the cycle in this case is 70 hours (4200 minutes). The cycle for changing the target temperature Tc is preferably between 2100 minutes and 21000 minutes. Although FIG. 17 illustrates transition for one cycle, the change in target temperature Tc is repeated periodically in the cycle as illustrated in FIG. 17.

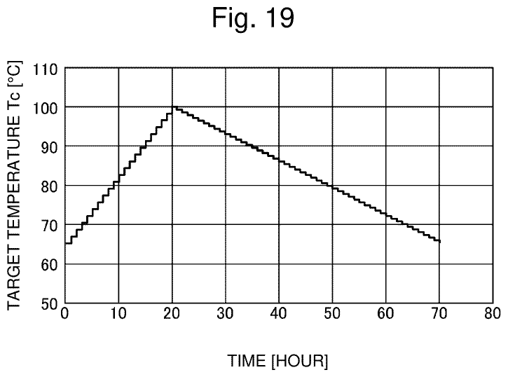

The target temperature Tc may be changed in a stepwise manner along a triangular wave as illustrated in FIG. 17, or the target temperature Tc may not only be changed along the triangular wave but also may be changed along a sine wave as illustrated in FIG. 18 or a sawtooth wave as illustrated in FIG. 19.

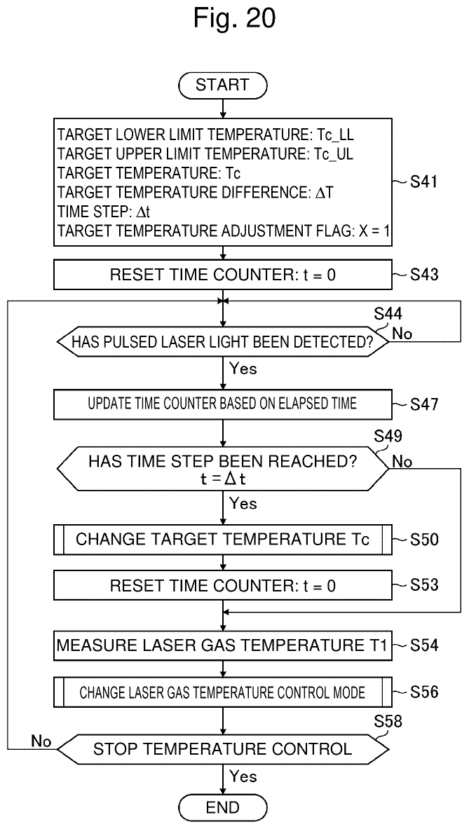

FIG. 20 illustrates a flowchart of the laser gas temperature control in the gas laser apparatus according to the Embodiment 2. Differences of the flowchart illustrated in FIG. 20 from the flowchart in FIG. 12 will be described.

The flowchart illustrated in FIG. 20 includes Steps S41 and S43 instead of Steps S40 and S42 in FIG. 12, and includes Steps S47, S49, and S53 instead of Steps S46, S48, and S52 in FIG. 12.

In Step S41, the laser control processor 8 sets a value of each of parameters, namely the target lower limit temperature Tc_LL, the target upper limit temperature Tc_UL, the target temperature Tc, a target temperature difference ΔT, a time step Δt, and a target temperature adjustment flag X. The setting of the values of Tc_LL, TC_UL, ΔT, and X may be similar to that in Step S40 in FIG. 12. The time step Δt may be, for example, between 30 minutes and 300 minutes.

In Step S43, the laser control processor 8 resets a time counter. In other words, the laser control processor 8 initializes the value of an elapsed time t stored in the time counter circuit provided in the laser control processor 8 to t=0.

After Step S43, the laser control processor 8 moves on to Step S44. In a case where Yes determination is made as a determination result in Step S44, the laser control processor 8 moves on to Step S47.

In Step S47, the laser control processor 8 updates the time counter based on the elapsed time. In other words, the value of the elapsed time t is updated by the time counter circuit.

In Step S49, the laser control processor 8 determines whether or not the elapsed time t has reached the time step Δt.

In a case where No determination is made as a determination result in Step S49, that is, in a case where the elapsed time t has not reached Δt, the processing proceeds to Step S54. On the other hand, in a case where Yes determination is made as a determination result in Step S49, that is, in a case where the elapsed time has reached Δt, the processing proceeds to Step S50 to execute the flow for changing the target temperature Tc of the laser gas.

Once the change in target temperature Tc of the laser gas is completed by Step S50, the processing proceeds to Step S53. In Step S53, the laser control processor 8 resets the time counter. In other words, the laser control processor 8 sets the elapsed time t to “0”. After Step S53, the laser control processor 8 moves on to Step S54.

The other steps are similar to those in FIG. 12, and the subroutines applied to Step S50 and Step S56 are also as illustrated in FIGS. 13 and 14.

In this manner, the laser control processor 8 repeats the operation of changing the target temperature Tc in a case where the elapsed time t increases by Δt based on the count value of the elapsed time t of the laser oscillation.

### 3.3 Effect and Advantage

An effect and an advantage of the Embodiment 2 are similar to those of the Embodiment 1.

### 4. Embodiment 3

### 4.1 Configuration

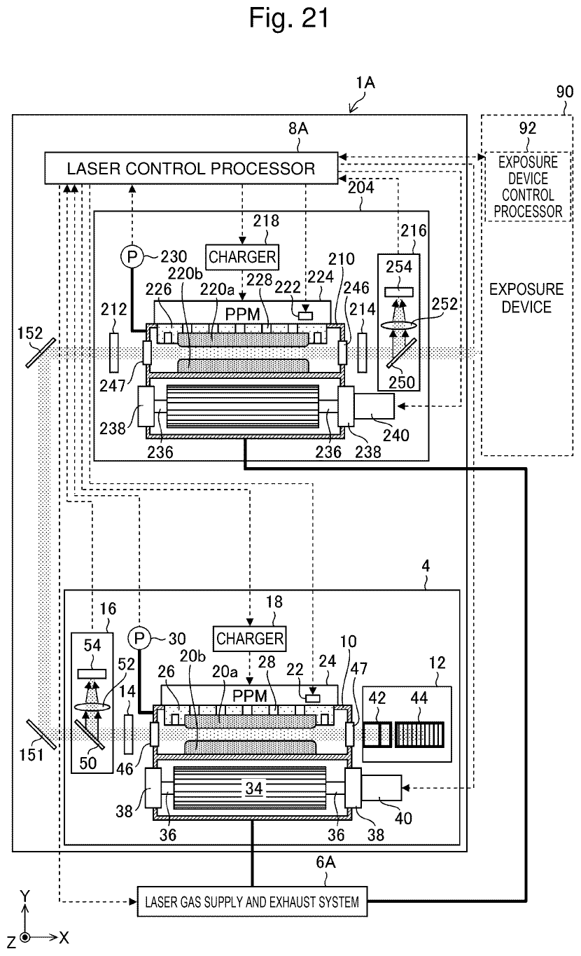

FIG. 21 schematically illustrates a configuration of a gas laser apparatus 1A according to an Embodiment 3. The Embodiment 3 is adapted to apply control to change a target temperature Tc of laser gas in accordance with an integrated value of the number of pulses to a laser oscillator system 4 of the gas laser apparatus 1A of a twin-chamber type. Note that the Embodiment 3 can also be applied to a case where the target temperature Tc is changed in accordance with an elapsed time, similar to the example described in the Embodiment 2.

Differences of the configuration of the gas laser apparatus 1A illustrated in FIG. 21 from that of the gas laser apparatus 1 illustrated in FIG. 1 will be described.

In the gas laser apparatus 1A of the twin-chamber type, laser light serving as seed light output from the laser oscillator system 4 illustrated in the lower part of FIG. 21 is amplified and output by a laser amplifier system 204 illustrated in the upper part of FIG. 21.

The gas laser apparatus 1A includes a laser control processor 8A that performs overall control on the laser amplifier system 204 and the laser oscillator system 4 and a laser gas supply and exhaust system 6A that supplies or exhausts laser gas to and from laser chambers 10 and 210 instead of the laser control processor 8 and the laser gas supply and exhaust system 6 in FIG. 1. In addition, the gas laser apparatus 1A includes high reflective mirrors 151 and 152 that guide the laser light output from the laser oscillator system 4 to the laser amplifier system 204.

The configuration of the laser oscillator system 4 in an oscillation stage is similar to that in FIG. 1. The laser light output from the laser oscillator system 4 passes through the high reflective mirrors 151 and 152 and is then transmitted through partial reflective mirror 212 of the laser amplifier system 204 in the later stage (amplification stage) before being input.

The laser amplifier system 204 includes the laser chamber 210, the partial reflective mirror 212, an OC 214, a power monitor 216, and a charger 218. Laser gas containing fluorine is sealed in the laser chamber 210. A pair of discharge electrodes 220a and 220b, a PPM 224 that includes a switch 222, an electrical insulating unit 226, and a feedthrough 228 are disposed in the laser chamber 210. Additionally, a pressure sensor 230, a cross-flow fan 234, a shaft 236 that causes the cross-flow fan 234 to rotate, a bearing 238 that fixes the shaft 236, and a motor 240 that provides a driving force to the shaft 236 are disposed in the laser chamber 210. The laser chamber 210 includes two windows 246 and 247 that transmit laser light. Although the basic configuration of the laser amplifier system 204 is similar to that of the laser oscillator system 4, the laser amplifier system 204 does not include an LNM mounted thereon and has a structure to amplify laser light by an optical resonator configured by the partial reflective mirror 212 and the OC 214. The amplified laser light is output from the OC 214.

The configuration of the power monitor 216 is similar to that of the power monitor 16, and the power monitor 216 includes a beam splitter 250, a light condensing lens 252, and an optical sensor 254, which are disposed on an optical path of the laser light output from the OC 214.

The configuration diagram of the laser oscillator system 4 rotated leftward by 90° in FIG. 21 is similar to that in FIG. 2, and the configuration of the laser gas temperature control system 80 of the laser chamber 10 is also similar to that in FIG. 2.

### 4.2 Operation

The laser control processor 8A generates discharge between the pair of discharge electrodes 220a and 220b of the laser amplifier system 204 at the timing at which the laser light is input to the laser amplifier system 204, and causes the laser gas to be excited. In this manner, the laser light input to the laser amplifier system 204 is amplified and oscillates. The laser control processor 8A causes the laser oscillator system 4 to execute an operation similar to that in the Embodiment 1. The laser oscillator system 4 is an example of the “laser oscillator” in the present disclosure. The laser amplifier system 204 is an example of the “laser amplifier” in the present disclosure.

### 4.3 Effect and Advantage

According to the Embodiment 3, an average beam profile of the seed light output from the laser oscillator system 4 has a reduced local peak intensity within the beam profile similarly to the Embodiment 1. Therefore, even in a case where there is a characteristic that the beam intensity within the beam profile becomes locally large in the laser amplifier system 204, the seed light with a reduced local peak intensity within the beam profile is input to the laser amplifier system 204, and it is thus possible to output amplified light with a small local peak intensity. It is thus possible to suppress degradation of optical elements and to extend the lifespan of the optical elements.

### 5. Embodiment 4

### 5.1 Configuration

An Embodiment 4 is adapted to apply control to change a target temperature of laser gas in accordance with an integrated value of a number of pulses in a laser amplifier system 204 in a gas laser apparatus 1A of a twin-chamber type. Note that the Embodiment 4 can also be applied to a case where the target temperature Tc is changed in accordance with an elapsed time similarly to the example described in the Embodiment 2.

The configuration of the gas laser apparatus 1A according to the Embodiment 4 may be similar to that in FIG. 21. However, a laser oscillator system 4 in the Embodiment 4 may have a configuration that does not include the laser gas temperature control system 80 described in FIG. 2. Instead, the laser amplifier system 204 includes a system similar to the laser gas temperature control system 80.

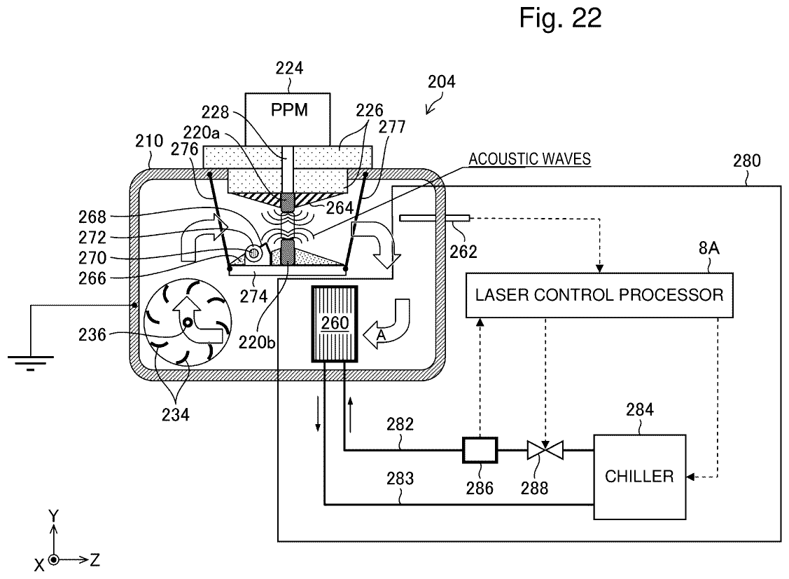

FIG. 22 illustrates a configuration diagram of the laser amplifier system 204 rotated leftward by 90° from that in FIG. 21. A heat exchanger 260, a temperature sensor 262, an insulating guide 264 and a metallic guide 266 that rectify the laser gas, a pre-ionization outer electrode 268, a pre-ionization inner electrode 270, a dielectric pipe 272 that cause corona discharge, a ground plate 274, and wirings 276 and 277 that hold the ground plate 274 in the laser chamber 210 are disposed in the laser chamber 210. The configuration and the function of each of these members may be similar to the configuration and the function of each corresponding member described in FIG. 2.

The gas laser apparatus 1A includes a laser gas temperature control system 280 that controls the temperature of the laser gas circulating in the laser chamber 210 in the direction of arrow A. The laser gas temperature control system 280 includes a laser control processor 8A, a temperature sensor 262, a heat exchanger 260, refrigerant pipings 282 and 283 that circulate a refrigerant inside the heat exchanger 260, and a chiller 284 that supplies the refrigerant to the heat exchanger 260 via the refrigerant pipings 282 and 283. The refrigerant piping 282 includes a flow rate sensor 286 and a valve 288. The configuration and the function of each of these members may be similar to the configuration and the function of each corresponding member described in FIG. 2.

### 5.2 Operation

The laser control processor 8A executes operations similar to those in the Embodiment 1 on the laser amplifier system 204.

### 5.3 Effect and Advantage

According to the Embodiment 4, the laser amplifier system 204 can output amplified light with a reduced local intensity even in a case where seed light with a large local intensity within a beam profile is input. It is thus possible to suppress degradation of optical elements and to extend the lifespan of the optical elements.

### 6. Embodiment 5

### 6.1 Configuration

The Embodiment 5 is adapted to apply control to change a target temperature Tc of laser gas in accordance with an integrated value of a number of pulses in both a laser oscillator system 4 and a laser amplifier system 204 in a gas laser apparatus 1A of a twin-chamber type. Note that the Embodiment 5 can also be applied to a case where the target temperature is changed in accordance with an elapsed time.

Configuration diagrams of the laser oscillator system 4 and the laser amplifier system 204 rotated leftward by 90° from those in FIG. 21 are similar to FIGS. 2 and 22, respectively.

### 6.2 Operation

The laser control processor 8A executes operations similar to those in the Embodiment 1 on both the laser oscillator system 4 and the laser amplifier system 204.

### 6.3 Effect and Advantage

According to the Embodiment 5, the a local intensity within each beam profile is reduced by both the laser oscillator system 4 and the laser amplifier system 204, and it is thus possible to output amplified light with the smallest local intensity as compared with the configurations in the Embodiment 3 and the Embodiment 4.

### 7. Electronic Device Manufacturing Method

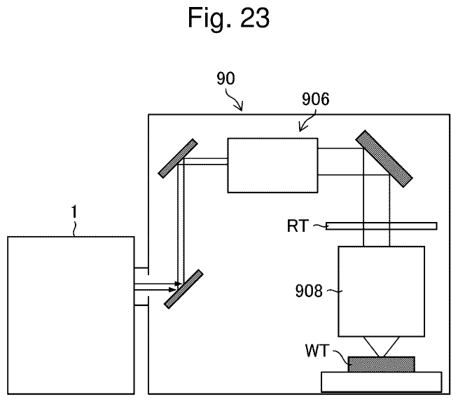

FIG. 23 schematically illustrates a configuration of an exposure device 90. The exposure device 90 includes an illumination optical system 906 and a projection optical system 908. The gas laser apparatus 1 generates laser light and outputs the laser light to the exposure device 90. The illumination optical system 906 illuminates, with the laser light incident from the gas laser apparatus 1, a reticle pattern of a reticle, which is not illustrated, disposed on a reticle stage RT. The projection optical system 908 projects the laser light transmitted through the reticle in a reduced size and forms an image of the laser light on a workpiece, which is not illustrated, disposed on a workpiece table WT. The workpiece is a photosensitive substrate such as a semiconductor wafer coated with a photoresist.

The exposure device 90 translates the reticle stage RT and the workpiece table WT in synchronization to thereby expose the workpiece to the laser light reflecting the reticle pattern. The reticle pattern is transferred to the semiconductor wafer through the exposure process as described above, and then a plurality of processes are performed to thereby manufacture a semiconductor device. The semiconductor device is an example of the “electronic device” in the present disclosure. The configuration is not limited to that using the gas laser apparatus according to the Embodiment 1 or the Embodiment 2 as the gas laser apparatus 1, and the gas laser apparatus 1A and the like described in the Embodiments 3 to 5 may also be used.

### 8. Others

Although an excimer laser apparatus has been described as an example of the gas laser apparatus in the Embodiments 1 to 5, the technology of the present disclosure is not limited to the excimer laser apparatus and can be applied to various kinds of gas laser apparatuses that perform laser oscillation through discharge-excitation of laser gas. Although the system of the master oscillator power oscillator (MOPO) type using the resonator in the amplification stage has been described in FIG. 21, the system is not limited thereto and may be a system of a master oscillator power amplifier (MOPA) that does not use a resonator in the amplification stage.

The description above is intended to be illustrative and the present disclosure is not limited thereto. Therefore, it would be obvious to those skilled in the art that various modifications to the embodiments of the present disclosure would be possible without departing from the spirit and the scope of the claims. Furthermore, it would be also obvious for those skilled in the art that embodiments of the present disclosure would be combined and used.

The terms used throughout the present specification and the appended claims should be interpreted as “non-limiting” terms unless expressly stated otherwise. For example, terms such as “comprise”, “include”, “have”, and “contain” should not be interpreted to be exclusive of other structural elements. Further, indefinite articles “a/an” should be interpreted to mean “at least one” or “one or more”. Furthermore, “at least one of A, B, and C” should be interpreted to mean any of A, B, C, A+B, A+C, B+C, and A+B+C In addition, combinations of any thereof and any other than “A”, “B”, and “C” should also be construed as being encompassed.

What is claimed is:

1. A gas laser apparatus that outputs pulsed laser light, the gas laser apparatus comprising:
a laser chamber that accommodates laser gas;
a discharge electrode that is disposed inside the laser chamber and is configured to cause discharge-excitation of the laser gas;
an optical element that is disposed on an optical path of the pulsed laser light; and
a processor configured to change a target temperature of the laser gas based on either a number of pulses of the pulsed laser light or an elapsed time during which the pulsed laser light is output.

2. The gas laser apparatus according to claim 1,
wherein the processor
minutely changes the target temperature based on the number of pulses or the elapsed time and changes the target temperature by regarding a period until the target temperature starting from a lower limit temperature reaches an upper limit temperature and then returns to the lower limit temperature as a cycle.

3. The gas laser apparatus according to claim 2,
wherein an amount of change when the target temperature is minutely changed is 0.5° C. to 1° C.

4. The gas laser apparatus according to claim 2,
wherein the lower limit temperature and the upper limit temperature are set such that a peak intensity with respect to an average intensity in an average beam profile of the pulsed laser light at each target temperature changed within a range from the lower limit temperature to the upper limit temperature is suppressed to 70% or less based on a peak intensity with respect to an average intensity in a beam profile of the pulsed laser light obtained in a case where the target temperature is fixed at a specific temperature.

5. The gas laser apparatus according to claim 2,
wherein the cycle is 350 Mpls to 3500 Mpls when expressed in terms of the number of pulses.

6. The gas laser apparatus according to claim 2,
wherein the cycle is 2100 minutes to 21000 minutes when expressed in terms of the elapsed time.

7. The gas laser apparatus according to claim 2,
wherein the lower limit temperature is 65° C., and the upper limit temperature is 100° C.

8. The gas laser apparatus according to claim 2,
wherein the processor changes the target temperature in a case where the number of pulses increases by 5 Mpls to 50 Mpls.

9. The gas laser apparatus according to claim 2,
wherein the processor changes the target temperature in a case where the elapsed time increases by 30 minutes to 300 minutes.

10. The gas laser apparatus according to claim 1,
wherein the optical element is any of a window, an output coupling mirror, and a line narrowing module prism disposed in the laser chamber.

11. The gas laser apparatus according to claim 1,
wherein the processor changes the target temperature for every specific number of pulses or every specific elapsed time.

12. The gas laser apparatus according to claim 1,
wherein the processor sets a lower limit temperature and an upper limit temperature of the target temperature, and
changes the target temperature at a plurality of levels within a range from the lower limit temperature to the upper limit temperature based on either the number of pulses or the elapsed time.

13. The gas laser apparatus according to claim 1, further comprising:
a temperature sensor configured to measure a temperature of the laser gas;
a heat exchanger that is disposed in the laser chamber;
a chiller configured to cool a refrigerant;
a piping configured to circulate the refrigerant between the heat exchanger and the chiller; and
a valve that is disposed in the piping,
wherein the processor adjusts a flow rate of the refrigerant to bring the laser gas closer to the target temperature by controlling the valve based on a measurement result of the temperature sensor.

14. The gas laser apparatus according to claim 1,
wherein the gas laser apparatus is a twin-chamber type including a laser oscillator and a laser amplifier configured to amplify seed light output from the laser oscillator, and
the change in the target temperature of the laser gas is applied to at least one of the laser oscillator and the laser amplifier.

15. A laser gas temperature control method for a gas laser apparatus that outputs pulsed laser light,
the gas laser apparatus including
a laser chamber that accommodates the laser gas,
a discharge electrode that is disposed inside the laser chamber and is configured to cause discharge-excitation of the laser gas,
an optical element that is disposed on an optical path of the pulsed laser light, and
a processor,
the method comprising, by the processor:
changing a target temperature of the laser gas based on either a number of pulses of the pulsed laser light or an elapsed time during which the pulsed laser light is output.

16. The laser gas temperature control method according to claim 15,
wherein the processor
minutely changes the target temperature based on the number of pulses or the elapsed time and periodically changes the target temperature by regarding a period until the target temperature starting from a lower limit temperature reaches an upper limit temperature and then returns to the lower limit temperature as a cycle.

17. The laser gas temperature control method according to claim 16,
wherein an amount of change when the target temperature is minutely changed is 0.5° C. to 1° C.

18. The laser gas temperature control method according to claim 16, comprising:
setting the lower limit temperature and the upper limit temperature such that a peak intensity with respect to an average intensity in an average beam profile of the pulsed laser light at each target temperature changed within a range from the lower limit temperature to the upper limit temperature is suppressed to 70% or less based on a peak intensity with respect to an average intensity in a beam profile of the pulsed laser light obtained in a case where the target temperature is fixed at a specific temperature.

19. An electronic device manufacturing method comprising:
generating laser light with a gas laser apparatus including
a laser chamber that accommodates laser gas,
a discharge electrode that is disposed inside the laser chamber and is configured to cause discharge-excitation of the laser gas,
an optical element that is disposed on an optical path of pulsed laser light, and
a processor configured to change a target temperature of the laser gas based on either a number of pulses of the pulsed laser light output by the discharge-excitation or an elapsed time during which the pulsed laser light is output;
outputting the laser light to an exposure apparatus; and
exposing a photosensitive substrate to the laser light within the exposure apparatus to manufacture an electronic device.
